(19) United States
(12) Patent Application Publication
(10) Pub. No.: US 2023/0350625 A1
(43) Pub. Date: Nov. 2, 2023

(54) DISPLAY METHOD AND DISPLAY SYSTEM

(71) Applicant: SEIKO EPSON CORPORATION, Tokyo (JP)

(72) Inventor: Naohiro FUJIMOTO, Kitaazumi-gun Ikeda-machi (JP)

(73) Assignee: SEIKO EPSON CORPORATION, Tokyo (JP)

(21) Appl. No.: 18/128,333

(22) Filed: Mar. 30, 2023

(30) Foreign Application Priority Data
Mar. 31, 2022 (JP) 2022-058547

(51) Int. Cl. G06F 3/14; G06F 1/16; G06F 3/04845; H04N 9/31

(52) U.S. Cl. CPC G06F 3/1423; G06F 1/1601; G06F 3/04845; H04N 9/312

(57) ABSTRACT

A display method includes: displaying, by a first display device, a first image including a plurality of control points; receiving, by the first display device, a first operation of selecting a selection point that is at least one control point among the plurality of control points; and projecting, by a second display device different from the first display device, a third image including a second image corresponding to the selection point at a first position corresponding to a position of the selection point in the first image.

The present application is based on, and claims priority from JP Application Serial Number 2022-058547, filed Mar. 31, 2022, the disclosure of which is hereby incorporated by reference herein in its entirety.

### BACKGROUND

### 1. Technical Field

The present disclosure relates to a display method and a display system.

### 2. Related Art

JP-A-2021-118465 discloses a position adjustment application that provides a graphical user interface (GUI) that allows a user to correct a shape of a projection image of a projector to any desired shape. For example, when the position adjustment application is launched on a personal computer (PC), an image including a plurality of grid points is displayed as the GUI on a display of the PC. The user can correct the shape of the projection image by performing an operation of selecting a grid point and an operation of moving the selected grid point while viewing the GUI displayed on the display.

According to the technique disclosed in JP-A-2021-118465, the user cannot easily determine to which position on the projection image a position of the grid point selected on the GUI corresponds, and thus convenience for the user is impaired.

### SUMMARY

A display method according to an aspect of the present disclosure includes: displaying, by a first display device, a first image including a plurality of control points; receiving, by the first display device, a first operation of selecting a selection point that is at least one control point among the plurality of control points; and projecting, by a second display device different from the first display device, a third image including a second image corresponding to the selection point, wherein a position of the second image in the third image is a first position corresponding to a position of the selection point in the first image.

A display system according to an aspect of the present disclosure includes: a first display device including a first processor configured to display a first image including a plurality of control points on a display device and to receive a first operation of selecting a selection point that is at least one control point among the plurality of control points; and a second display device different from the first display device, the second display device including a second processor configured to control a projection device to project a third image including a second image corresponding to the selection point, wherein a position of the second image in the third image is a first position corresponding to a position of the selection point in the first image.

### BRIEF DESCRIPTION OF THE DRAWINGS

FIG. 1 is a block diagram schematically showing a configuration of a display system according to an embodiment.

FIG. 2 is a flowchart showing a first process executed by a first processor of a first display device.

FIG. 3 shows an example of an input image indicated by image data in a video signal.

FIG. 4 shows an example of a grid pattern image displayed in an application window.

FIG. 5 is a flowchart showing a second process executed by a second processor of a second display device.

FIG. 6 shows an example of a first superimposed image in which a selection point image is superimposed on an input image.

FIG. 7 shows a state in which trapezoidal distortion occurs in the first superimposed image projected onto a projection surface.

FIG. 8 is a flowchart showing a third process executed by the first processor of the first display device.

FIG. 9 shows a state in which a selection point moves in a grid pattern image.

FIG. 10 is a flowchart showing a fourth process executed by the second processor of the second display device.

FIG. 11 shows an example of a second superimposed image in which a selection point image is superimposed on an input image whose shape is corrected.

FIG. 12 shows a second superimposed image projected onto a projection surface.

FIG. 13 shows a modification of the first superimposed image.

FIG. 14 shows a modification of the first superimposed image.

### DESCRIPTION OF EXEMPLARY EMBODIMENTS

Hereinafter, an embodiment of the present disclosure will be described with reference to the drawings.

In the following drawings, in order to make each constituent element easy to view, a scale of a dimension may be changed depending on the constituent element.

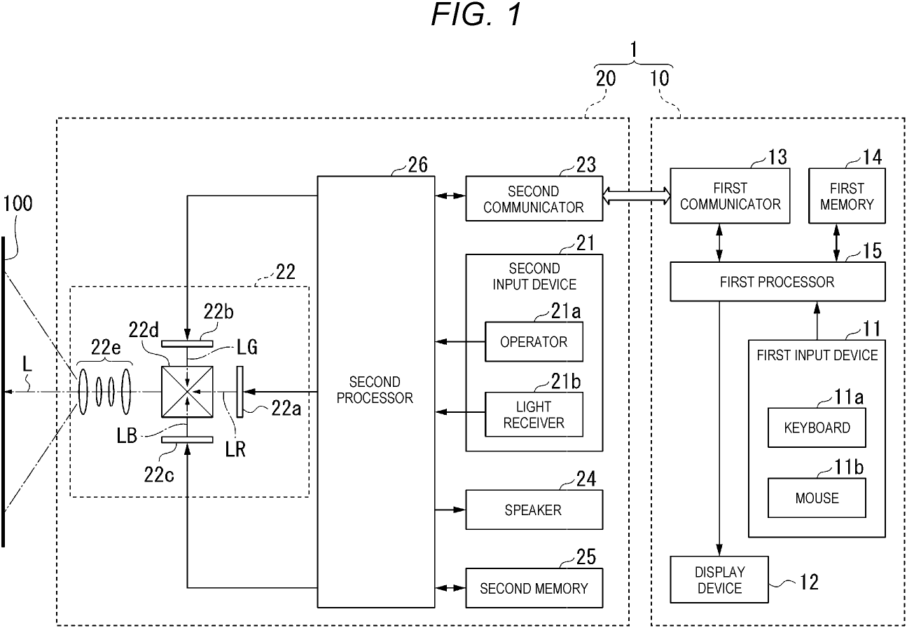

FIG. 1 is a block diagram schematically showing a configuration of a display system 1 according to the embodiment. As shown in FIG. 1, the display system 1 includes a first display device 10 and a second display device 20. The first display device 10 is an information processing device having an image display function, such as a desktop PC, a notebook PC, a tablet terminal, or a smartphone. More specifically, the first display device 10 is a device capable of launching a predetermined application and displaying a GUI provided by the application. As an example, the first display device 10 according to the embodiment is a notebook PC.

The second display device 20 is a display device different from the first display device 10. As an example, the second display device 20 according to the embodiment is a projector that displays an image on a projection surface 100 by projecting an image light L onto the projection surface 100. The projection surface 100 may be a dedicated projector screen or a wall surface. In the following description, the projection of the image light L projected by the second display device 20 may be referred to as “projection of an image by the second display device 20”.

The first display device 10 and the second display device 20 are connected to each other via a communication cable (not shown). The first display device 10 supplies a video signal to the second display device 20 via the communication cable. The second display device 20 generates the image light L based on the video signal supplied from the first display device 10, and projects the generated image light L onto the projection surface 100.

The first display device 10 includes a first input device 11, a display device 12, a first communicator 13, a first memory 14, and a first processor 15. The second display device 20 includes a second input device 21, a projection device 22, a second communicator 23, a speaker 24, a second memory 25, and a second processor 26.

The first input device 11 is a device that receives an input operation performed by a user on the first display device 10. As an example, the first input device 11 includes a keyboard 11a and a mouse 11b. The first input device 11 outputs an electrical signal generated by an operation of the user on the keyboard 11a and the mouse 11b to the first processor 15 as a first operation signal.

The display device 12 is a display panel that is controlled by the first processor 15 so as to display a predetermined image. For example, the display device 12 is a thin display such as a liquid crystal display or an organic electro-luminescence (EL) display mounted on the first display device 10 which is a notebook PC.

The first communicator 13 is a communication interface connected to the second communicator 23 of the second display device 20 via a communication cable, and includes, for example, an interface circuit. The first communicator 13 outputs a signal received from the second communicator 23 to the first processor 15. In addition, the first communicator 13 transmits various signals such as a video signal input from the first processor 15 to the second communicator 23.

The first memory 14 includes a non-volatile memory that stores programs required for the first processor 15 to execute various processes, various types of setting data, and the like, and a volatile memory used as a temporary storage of data when the first processor 15 executes various processes. For example, the non-volatile memory is an electrically erasable programmable read-only memory (EEPROM), or a flash memory. The volatile memory is, for example, a random access memory (RAM). The programs stored in the first memory 14 also include software of an image adjustment application to be described later.

The first processor 15 is an arithmetic processing device that controls an overall operation of the first display device 10 according to a program stored in advance in the first memory 14. As an example, the first processor 15 includes one or more central processing units (CPUs). A part or all of functions of the first processor 15 may be implemented by circuits such as a digital signal processor (DSP), an application specific integrated circuit (ASIC), a programmable logic device (PLD), and a field programmable gate array (FPGA). The first processor 15 executes various processes in parallel or sequentially.

For example, the first processor 15 executes a predetermined process based on the first operation signal input from the first input device 11 and a signal received from the second display device 20 via the first communicator 13, and displays an image indicating a process result thereof on the display device 12. In addition, the first processor 15 transmits various signals such as a signal indicating the process result and a video signal to the second display device 20 via the first communicator 13.

The second input device 21 is a device that receives an input operation performed by the user on the second display device 20. As an example, the second input device 21 includes an operator 21a and a light receiver 21b. The operator 21a includes a plurality of operation keys provided on the second display device 20. For example, the operation keys include a power key, a menu call key, a direction key, an enter key, and a volume adjustment key. The operation keys may be hardware keys or software keys displayed on a touch panel provided on the second display device 20. The operator 21a outputs an electrical signal generated in response to an operation performed by the user on each operation key to the second processor 26 as a second operation signal.

The light receiver 21b includes a photoelectric conversion circuit that receives infrared light transmitted from a remote controller (not shown) of the second display device 20 and converts the infrared light into an electrical signal. The light receiver 21b outputs the electrical signal obtained by the photoelectric conversion of the infrared light to the second processor 26 as a remote operation signal. The remote controller is provided with a plurality of operation keys similarly to the operator 21a. The remote controller converts an electrical signal generated in response to an operation performed by the user on each operation key provided on the remote controller into infrared light and transmits the infrared light to the second display device 20. That is, the remote operation signal output from the light receiver 21b is substantially the same as the electrical signal generated in response to the operation performed by the user on each operation key of the remote controller. In a case where the remote controller transmits a radio wave signal according to a short-range wireless communication standard such as Bluetooth (registered trademark), a receiving device that receives the radio wave signal may be provided instead of the light receiver 21b.

The projection device 22 is controlled by the second processor 26 so as to generate the image light L representing a color image and project the generated image light L toward the projection surface 100. The projection device 22 includes a first image generation panel 22a, a second image generation panel 22b, a third image generation panel 22c, a dichroic prism 22d, and a projection optical system 22e.

The first image generation panel 22a generates red image light LR representing a red image and emits the red image light LR to the dichroic prism 22d. The first image generation panel 22a includes a plurality of pixels arranged in a matrix, and each of the plurality of pixels emits red light. An amount of the emitted red light is controlled for each pixel by the second processor 26, and thus the red image light LR is emitted from the first image generation panel 22a.

The second image generation panel 22b generates green image light LG representing a green image and emits the green image light LG to the dichroic prism 22d. The second image generation panel 22b includes a plurality of pixels arranged in a matrix, and each of the plurality of pixels emits green light. An amount of the emitted green light is controlled for each pixel by the second processor 26, and thus the green image light LG is emitted from the second image generation panel 22b.

The third image generation panel 22c generates blue image light LB representing a blue image and emits the blue image light LB to the dichroic prism 22d. The third image generation panel 22c includes a plurality of pixels arranged in a matrix, and each of the plurality of pixels emits blue light. An amount of the emitted blue light is controlled for each pixel by the second processor 26, and thus the blue image light LB is emitted from the third image generation panel 22c.

For example, each of the image generation panels 22a, 22b, and 22c is a self-luminous electro-optical device such as an organic light emitting diode (OLED) panel or a micro light emitting diode (uLED) panel. Each of the image generation panels 22a, 22b, and 22c may also be a non-self-luminous electro-optical device such as a liquid crystal panel or a digital micromirror device (DMD). In a case where each of the image generation panels 22a, 22b, and 22c is a non-self-luminous electro-optical device, light from a light source (not shown) such as an LED is separated into red light, green light, and blue light. The red light is incident on the first image generation panel 22a. The green light is incident on the second image generation panel 22b. The blue light is incident on the third image generation panel 22c. In addition, light of each color may be emitted in a time division manner by using a single-panel image generation panel.

The dichroic prism 22d combines the red image light LR, the green image light LG, and the blue image light LB so as to generate the image light L representing a color image, and emits the image light L to the projection optical system 22e. The projection optical system 22e includes a plurality of optical elements such as lenses, enlarges the image light L emitted from the dichroic prism 22d and projects the image light L toward the projection surface 100. Although not shown, the projection optical system 22e is provided with mechanisms capable of adjusting optical parameters such as a lens shift amount, a lens focus amount, and a lens zoom amount. By controlling these mechanisms by the second processor 26, the optical parameters of the projection optical system 22e are adjusted.

The second communicator 23 is a communication interface connected to the first communicator 13 of the first display device 10 via a communication cable, and includes, for example, an interface circuit. The second communicator 23 outputs various signals such as a video signal received from the first communicator 13 to the second processor 26. In addition, the second communicator 23 transmits a signal input from the second processor 26 to the first communicator 13.

The speaker 24 is controlled by the second processor 26 so as to output audio having a predetermined volume.

The second memory 25 includes a non-volatile memory that stores programs required for the second processor 26 to execute various processes, various types of setting data, and the like, and a volatile memory used as a temporary storage of data when the second processor 26 executes various processes. The programs stored in the second memory 25 also include an image shape correction program to be described later.

The second processor 26 is an arithmetic processing device that controls an overall operation of the second display device 20 according to a program stored in advance in the second memory 25. As an example, the second processor 26 is configured with one or more CPUs. A part or all of functions of the second processor 26 may be implemented by circuits such as a DSP, an ASIC, a PLD, and an FPGA. The second processor 26 executes various processes in parallel or sequentially.

For example, the second processor 26 controls the projection device 22 and the speaker 24 based on the second operation signal input from the operator 21a, the remote operation signal input from the light receiver 21b, and a signal received from the first display device 10 via the second communicator 23. Specifically, the second processor 26 controls the projection device 22 such that an image based on image data in a video signal supplied from the first display device 10 is projected, and controls the speaker 24 such that audio based on audio data in the video signal is output.

Next, an operation of the display system 1 configured as described above will be described.

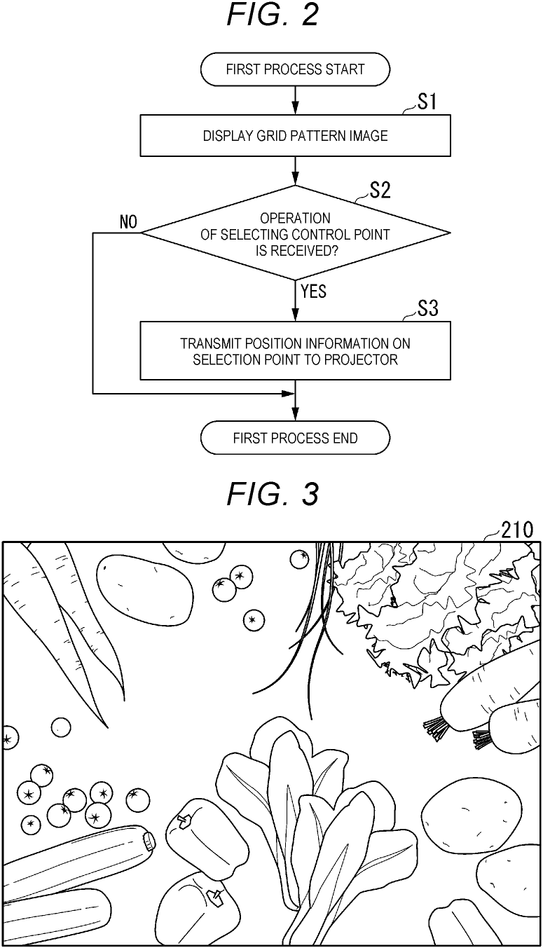

FIG. 2 is a flowchart showing a first process executed by the first processor 15 of the first display device 10. Upon receiving an operation of launching the image adjustment application, the first processor 15 reads the software of the image adjustment application from the first memory 14 and executes the software so as to execute the first process shown in FIG. 2.

The first processor 15 transmits a video signal to the second display device 20 via the first communicator 13 before receiving the operation of launching the image adjustment application. The video signal may be a video signal downloaded from the Internet, or may be a video signal of a digital versatile disc (DVD) read by a DVD drive (not shown) mounted on the first display device 10. As an example, in the embodiment, the first processor 15 transmits a video signal including image data indicating an input image 210 that is a still image to the second display device 20.

FIG. 3 shows an example of the input image 210 indicated by the image data in the video signal. For example, the input image 210 is an image obtained by capturing an image of a plurality of types of vegetables. The input image 210 is an image that is input to the first display device 10 via the Internet, the DVD drive, or the like as described above, and is an original image that is not subjected to image processing such as color correction and shape correction after being input to the first display device 10. The input image 210 corresponds to a “fourth image”.

Upon receiving the video signal from the first display device 10 via the second communicator 23, the second processor 26 of the second display device 20 controls the projection device 22 such that the image light L representing the input image 210 is projected based on the image data in the video signal. In this way, when the input image 210 is projected onto the projection surface 100, distortion such as trapezoidal distortion may occur in the input image 210 depending on a state of the projection surface 100. That is, the input image 210 that is actually projected onto the projection surface 100 and visually recognized by the user as a display image may be different from the input image 210 indicated by the image data in the video signal.

Upon recognizing that the distortion occurs in the input image 210 projected onto the projection surface 100, that is, the input image 210 visually recognized as the display image, the user performs the operation of launching the image adjustment application in order to prevent the distortion of the input image 210 projected onto the projection surface 100. The operation of launching the image adjustment application is, for example, a double click on an icon for launching the image adjustment application displayed on a screen of the display device 12 by the user using the mouse 11b.

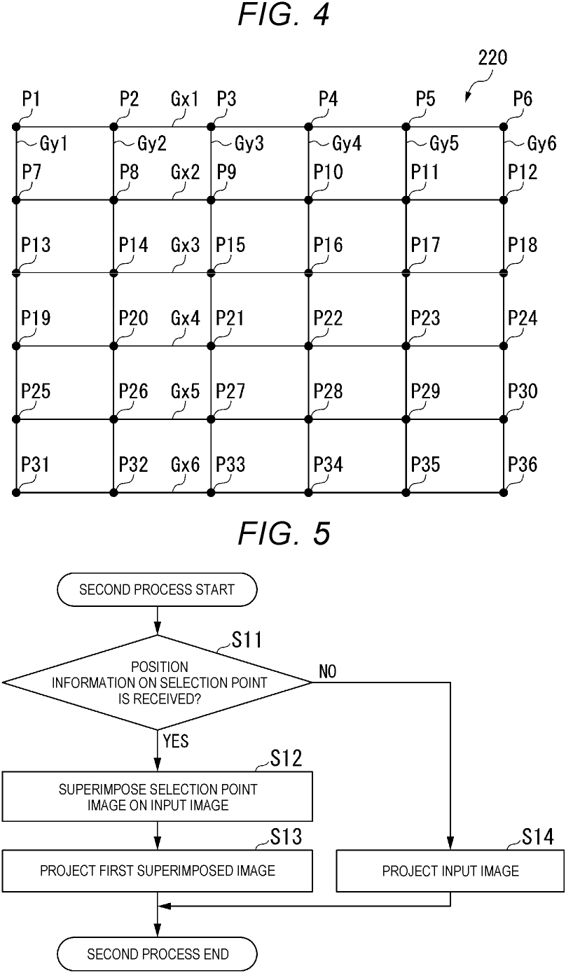

As shown in FIG. 2, when the first process is started, the first processor 15 first displays, on the display device 12, an application window including a grid pattern image 220 as a GUI (step S1). FIG. 4 shows an example of the grid pattern image 220 displayed in the application window. The grid pattern image 220 corresponds to a “first image including a plurality of control points”.

As shown in FIG. 4, as an example, the grid pattern image 220 in the embodiment includes 36 control points P1 to P36. In the grid pattern image 220, the control points P1 to P36 are arranged in a grid pattern. The grid pattern image 220 further includes six horizontal grid lines G×1 to G×6 extending in a horizontal direction of the grid pattern image 220 and six vertical grid lines Gy1 to Gy6 extending in a vertical direction of the grid pattern image 220. The horizontal grid lines G×1 to G×6 are arranged at equal intervals along the vertical direction. The vertical grid lines Gy1 to Gy6 are arranged at equal intervals along the horizontal direction.

In the following description, when it is not necessary to distinguish between the control points P1 to P36, the control points P1 to P36 are collectively referred to as a control point P. In addition, when it is not necessary to distinguish between the horizontal grid lines G×1 to G×6, the horizontal grid lines G×1 to G×6 are collectively referred to as a horizontal grid line Gx. In addition, when it is not necessary to distinguish between the vertical grid lines Gy1 to Gy6, the vertical grid lines Gy1 to Gy6 are collectively referred to as a vertical grid line Gy.

The control points P1 to P6 are arranged at equal intervals on the horizontal grid line G×1. The control points P1 to P6 are intersections of each of the vertical grid lines Gy1 to Gy6 and the horizontal grid line G×1. The control points P7 to P12 are arranged at equal intervals on the horizontal grid line G×2. The control points P7 to P12 are intersections of each of the vertical grid lines Gy1 to Gy6 and the horizontal grid line G×2. The control points P13 to P18 are arranged at equal intervals on the horizontal grid line G×3. The control points P13 to P18 are intersections of each of the vertical grid lines Gy1 to Gy6 and the horizontal grid line G×3.

The control points P19 to P24 are arranged at equal intervals on the horizontal grid line G×4. The control points P19 to P24 are intersections of each of the vertical grid lines Gy1 to Gy6 and the horizontal grid line G×4. The control points P25 to P30 are arranged at equal intervals on the horizontal grid line G×5. The control points P25 to P30 are intersections of each of the vertical grid lines Gy1 to Gy6 and the horizontal grid line G×5. The control points P31 to P36 are arranged at equal intervals on the horizontal grid line G×6. The control points P31 to P36 are intersections of each of the vertical grid lines Gy1 to Gy6 and the horizontal grid line G×6.

Although the control points P1 to P36 in the grid pattern image 220 are represented by black circles in FIG. 4, the control points P1 to P36 are not necessarily represented by images such as black circles. As described above, since the user can easily understand that the intersection of the horizontal grid line Gx and the vertical grid line Gy is the control point P, the control point P may be represented simply by the horizontal grid line Gx and the vertical grid line Gy.

Referring back to FIG. 2 to continue the description, the first processor 15 displays, on the display device 12, the grid pattern image 220, and then determines whether a selection operation of selecting at least one control point P within a predetermined time is received based on the first operation signal input from the first input device 11 (step S2). The selection operation corresponds to a “first operation”.

The selection operation is, for example, clicking at least one control point P among the control points P1 to P36 in the grid pattern image 220 by the user using the mouse 11b. Alternatively, a plurality of control points P may be collectively selected in a range designated by a drag operation of the user using the mouse 11b. The first processor 15 may recognize one pixel among pixels in the grid pattern image 220 as one control point P, or may recognize one region including a plurality of pixels as one control point P.

When it is determined that the selection operation of selecting at least one control point P is received (step S2: Yes), the first processor 15 transmits position information on the selection point that is the control point P selected by the selection operation to the second display device 20 via the first communicator 13 (step S3). As an example, the position information on the selection point is coordinates of the selection point in the grid pattern image 220.

For example, in a case where one pixel among the pixels in the grid pattern image 220 is recognized as one control point P, the first processor 15 acquires coordinates of the pixel corresponding to the control point P selected as the selection point as the position information on the selection point. In addition, for example, in a case where one region including a plurality of pixels among the pixels in the grid pattern image 220 is recognized as one control point P, the first processor 15 acquires coordinates of a pixel located at a center of the region corresponding to the control point P selected as the selection point as the position information on the selection point.

The first processor 15 transmits the position information on the selection point to the second display device 20 and then ends the first process. In addition, when it is determined that the selection operation of selecting at least one control point P is not received within the predetermined time (step S2: No), the first processor 15 skips step S3 and ends the first process. The first processor 15 repeatedly executes the first process at regular time intervals during running of the image adjustment application. For example, in a case where a refresh rate of the display device 12 is 60 Hz, the first processor 15 repeatedly executes the first process at intervals of 16 ms.

FIG. 5 is a flowchart showing a second process executed by the second processor 26 of the second display device 20. Upon receiving an operation of turning on an image correction mode, the second processor 26 reads the image shape correction program from the second memory 25 and executes the image shape correction program so as to execute the second process shown in FIG. 5.

Upon recognizing that the distortion occurs in the input image 210 projected onto the projection surface 100, the user performs the operation of launching the image adjustment application and the operation of turning on the image correction mode. The operation of turning on the image correction mode is, for example, pressing an image correction mode button provided on the remote controller of the second display device 20 by the user.

In parallel with executing the second process, the second processor 26 stores the image data in the video signal received from the first display device 10 via the second communicator 23 in frame units in the second memory 25. The image data in the video signal is data indicating the input image 210.

As shown in FIG. 5, when the second process is started, the second processor 26 first determines whether position information on the selection point is received from the first display device 10 within a predetermined time (step S11) . When it is determined that the position information on the selection point is received within the predetermined time (step S11: Yes), the second processor 26 generates a first superimposed image 240 by superimposing a selection point image 230 corresponding to the selection point on the input image 210 (step S12). The selection point image 230 corresponds to a “second image”. The first superimposed image 240 corresponds to a “third image”.

Specifically, in step S12, the second processor 26 reads the image data indicating the input image 210 of a current frame from the second memory 25, and generates the first superimposed image 240 in which the selection point image 230 is superimposed on the input image 210 based on the read image data. In addition, the second processor 26 superimposes the selection point image 230 at a first position corresponding to a position of the selection point in the grid pattern image 220 among positions (coordinates) on the input image 210 based on the position information on the selection point.

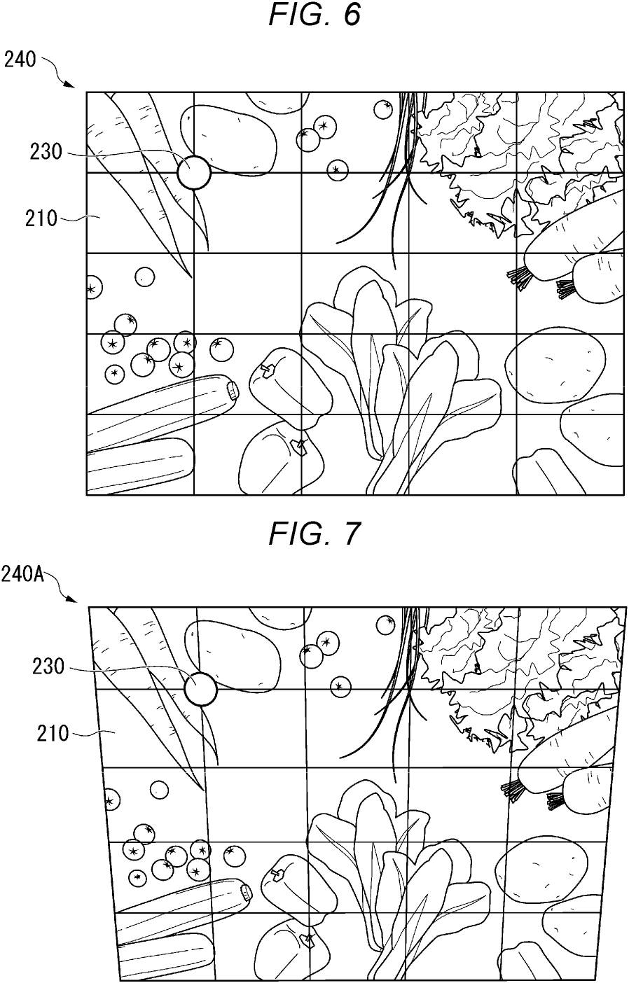

FIG. 6 shows an example of the first superimposed image 240 in which the selection point image 230 is superimposed on the input image 210. As shown in FIG. 6, the first superimposed image 240 includes the selection point image 230 corresponding to the selection point. A position of the selection point image 230 in the first superimposed image 240 is a first position corresponding to the position of the selection point in the grid pattern image 220. For example, when the control point P8 is selected as the selection point among the control points P1 to P36 in the grid pattern image 220, as shown in FIG. 6, the selection point image 230 is superimposed at the first position corresponding to a position of the control point P8 in the grid pattern image 220 among the positions on the input image 210.

In FIG. 6, in order to facilitate understanding of a correspondence relationship between the first superimposed image 240 and the grid pattern image 220, lines corresponding to the horizontal grid line Gx and the vertical grid line Gy in the grid pattern image 220 are disposed in the first superimposed image 240. However, the lines corresponding to the horizontal grid line Gx and the vertical grid line Gy are not necessarily disposed in the first superimposed image 240. The first superimposed image 240 may be an image in which the selection point image 230 is superimposed at the first position on the input image 210.

As shown in FIG. 6, as an example, the selection point image 230 has a circular shape. The shape of the selection point image 230 is not limited to the circular shape, and is preferably a shape that is easily recognizable visually by the user. The selection point image 230 has a first color based on a color indicated by at least one pixel in a predetermined range from the first position in the input image 210 among pixels in the input image 210. As an example, the first color is a complementary color of a second color determined based on the color indicated by the at least one pixel in the predetermined range from the first position among the pixels in the input image 210.

For example, the second processor 26 calculates, as the second color, an average value of colors indicated by a plurality of pixels within a contour of the selection point image 230 centered on the first position among the pixels in the input image 210. In this case, the predetermined range is a range from the first position to inside of the contour of the selection point image 230. Alternatively, for example, the second processor 26 calculates, as the second color, an average value of colors indicated by a plurality of pixels in a region outside the contour of the selection point image 230 centered on the first position among the pixels in the input image 210. In this case, the predetermined range is a range from the first position to the region outside the contour of the selection point image 230. The region outside the contour is, for example, a range including a region 5 pixels away from the contour. The second processor 26 may calculate an average value for each of the three colors including red, green, and blue. After calculating the second color as described above, the second processor 26 sets the first color in the selection point image 230 to the complementary color of the second color. The first color in the selection point image 230 is not limited to the complementary color of the second color, and is preferably a color that is easily recognizable visually by the user.

Referring back to FIG. 5 to continue the description, the second processor 26 generates the first superimposed image 240 as described above, and then causes the projection device 22 to project the first superimposed image 240 (step S13). Specifically, in step S13, the second processor 26 controls the projection device 22 to project the image light L representing the first superimposed image 240 based on image data indicating the first superimposed image 240. After causing the projection device 22 to project the first superimposed image 240, the second processor 26 ends the second process.

On the other hand, when it is determined that the position information on the selection point is not received within the predetermined time (step S11: No), the second processor 26 causes the projection device 22 to project the input image 210 of the current frame (step S14). Specifically, in step S14, the second processor 26 reads image data indicating the input image 210 of the current frame from the second memory 25, and controls the projection device 22 to project the image light L representing the input image 210 based on the read image data. After causing the projection device 22 to project the input image 210, the second processor 26 ends the second process.

The second processor 26 repeatedly executes the second process at regular time intervals while the image correction mode is turned on. For example, in a case where a frame rate of the video signal is 60 frames per second, the second processor 26 repeatedly executes the second process at intervals of 16 ms.

As described above, the first processor 15 of the first display device 10 causes the display device 12 to display the grid pattern image 220 including the plurality of control points P, and receives the selection operation of selecting the selection point that is at least one control point P among the plurality of control points P. In addition, the second processor 26 of the second display device 20 causes the projection device 22 to project the first superimposed image 240 including the selection point image 230 corresponding to the selection point at the first position corresponding to the position of the selection point in the grid pattern image 220.

The first processor 15 of the first display device 10 executes the first process according to the software of the image adjustment application, the second processor 26 of the second display device 20 executes the second process according to the image shape correction program, and thus the display method according to the embodiment is implemented.

That is, the display method according to the embodiment includes: displaying, by the first display device 10, the grid pattern image 220 including the plurality of control points P; receiving, by the first display device 10, the selection operation of selecting the selection point that is at least one control point P among the plurality of control points P; and projecting, by the second display device 20 different from the first display device 10, the first superimposed image 240 including the selection point image 230 corresponding to the selection point at the first position corresponding to the position of the selection point in the grid pattern image 220.

When distortion occurs in the input image 210 projected onto the projection surface 100, similar distortion also occurs in the first superimposed image 240 projected onto the projection surface 100. That is, the first superimposed image 240 that is actually projected onto the projection surface 100 and visually recognized by the user as a display image may be different from the first superimposed image 240 generated by the second processor 26. In the following description, in order to distinguish the first superimposed image 240 visually recognized as the display image by the user from the first superimposed image 240 generated by the second processor 26, the first superimposed image 240 visually recognized as the display image by the user may be referred to as a “first superimposed display image 240A”.

FIG. 7 shows a state in which trapezoidal distortion occurs in the first superimposed image 240 projected onto the projection surface 100. In this case, the first superimposed image 240 projected onto the projection surface 100 is visually recognized by the user as the first superimposed display image 240A having trapezoidal distortion. Even when the projection surface 100 is flat, in a case where a projection optical axis of the projection device 22 is not orthogonal to the projection surface 100, the first superimposed display image 240A having trapezoidal distortion as shown in FIG. 7 is displayed on the projection surface 100. Similarly, the input image 210 projected onto the projection surface 100 is also visually recognized by the user as a display image having trapezoidal distortion.

In order to prevent the trapezoidal distortion from occurring in the input image 210 projected onto the projection surface 100 in this manner, the input image 210 whose shape is corrected may be projected after performing shape correction of applying trapezoidal distortion in an opposite direction to the input image 210. As will be described later, the user can correct the input image 210 into any desired shape by performing a moving operation of changing the position of the selection point in the grid pattern image 220 displayed as the GUI on the display device 12 while viewing the image projected on the projection surface 100.

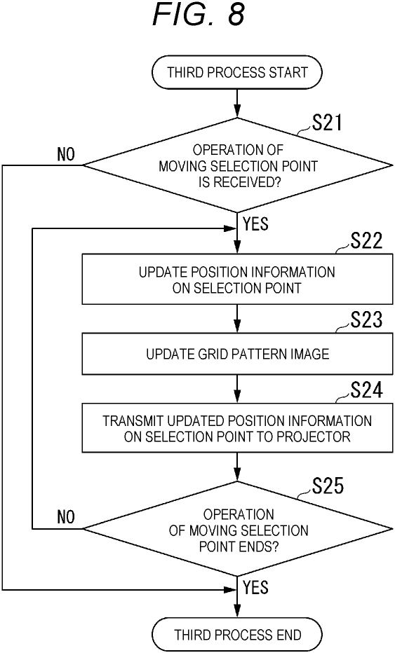

FIG. 8 is a flowchart showing a third process executed by the first processor 15 of the first display device 10. Upon receiving the operation of launching the image adjustment application, the first processor 15 reads the software of the image adjustment application from the first memory 14 and executes the software so as to execute the third process shown in FIG. 8 in parallel with the first process described above.

As shown in FIG. 8, when the third process is started, the first processor 15 first determines, based on the first operation signal input from the first input device 11, whether the moving operation of changing the position of the selection point is received within a predetermined time (step S21). The moving operation corresponds to a “second operation”. The moving operation is, for example, moving the selection point by dragging at least one of selection points in the grid pattern image 220 by the user using the mouse 11b.

When it is determined that the moving operation of changing the position of the selection point is received within the predetermined time (step S21: Yes), the first processor 15 updates the position information on the selection point on which the moving operation is performed to position information on the selection point at a current time (step S22). In the following description, the updated position information is referred to as updated position information. The first processor 15 updates the grid pattern image 220 based on the updated position information on the selection point (step S23) . The first processor 15 transmits the updated position information on the selection point to the second display device 20 via the first communicator 13 (step S24).

The first processor 15 determines whether the moving operation of the selection point ends based on the first operation signal input from the first input device 11 (step S25). For example, when it is detected that a left click button of the mouse 11b is released after the drag operation performed on the mouse 11b by the user is detected, the first processor 15 determines that the moving operation of the selection point ends. When it is determined that the moving operation of the selection point does not end (step S25: No), the first processor 15 returns to step S22. On the other hand, when it is determined that the moving operation of the selection point ends (step S25: Yes), the first processor 15 ends the third process. In addition, when it is determined that the moving operation of changing the position of the selection point is not received within the predetermined time (step S21: No), the first processor 15 skips steps S22 to S25 and ends the third process.

As described above, the first processor 15 repeatedly executes the processes of steps S22 to S24 after receiving the moving operation of the selection point until the moving operation ends, so that the user can visually recognize a state in which the selection point moves following the moving operation of the user and the grid pattern image 220 changes along with the movement of the selection point.

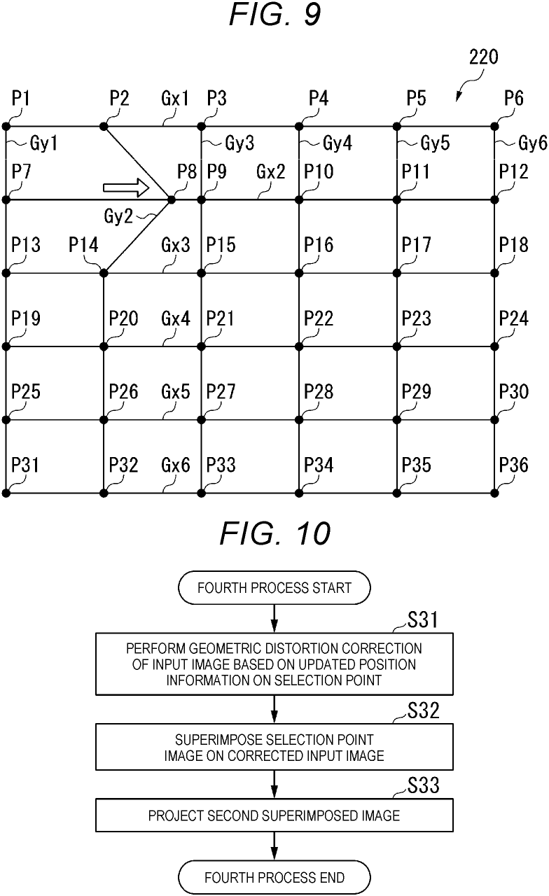

FIG. 9 shows a state in which the selection point moves in the grid pattern image 220. FIG. 9 shows, as an example, a case where the control point P8 is selected as the selection point, and a moving operation of moving the control point P8 that is the selection point to a position on a right side is performed. In this case, the first processor 15 repeatedly executes the processes of steps S22 to S24 after receiving the moving operation of the selection point (control point P8) until the moving operation ends, so that the user can visually recognize a state in which the selection point (control point P8) moves rightward following the moving operation of the user and a shape of the vertical grid line Gy2 in the grid pattern image 220 changes along with the movement of the selection point (control point P8).

FIG. 10 is a flowchart showing a fourth process executed by the second processor 26 of the second display device 20. Upon receiving the operation of turning on the image correction mode, the second processor 26 reads the image shape correction program from the second memory 25 and executes the image shape correction program so as to execute the fourth process shown in FIG. 10 in parallel with the second process.

As shown in FIG. 10, upon receiving the updated position information on the selection point from the first display device 10 via the second communicator 23, the second processor 26 reads the image data indicating the input image 210 of a current frame from the second memory 25, and performs geometric distortion correction (shape correction) of the input image 210 based on the updated position information on the selection point and the image data (step S31).

The image data indicating the input image 210 is data in which coordinates of each pixel constituting the input image 210 are associated with grayscale data indicating brightness (grayscale value) of the pixel. In other words, the image data indicating the input image 210 is data that defines a correspondence relationship between the coordinates and the grayscale data of each pixel constituting the input image 210. The geometric distortion correction is to modify the correspondence relationship between the coordinates and the grayscale data of each pixel based on the updated position information on the selection point. For example, grayscale data associated with a first coordinate pair (x1, y1) is associated with a second coordinate pair (x2, y2) different from the first coordinate pair. Since such geometric distortion correction (shape correction) of an image is a known technique as disclosed in JP-A-2021-118465, detailed description of the geometric distortion correction will be omitted in the embodiment.

In the following description, the input image 210 whose shape is corrected by the geometric distortion correction is referred to as a “corrected input image 210A”. The second processor 26 generates a second superimposed image 250 in which the selection point image 230 is superimposed on the corrected input image 210A based on image data indicating the corrected input image 210A (step S32). The second superimposed image 250 corresponds to a “sixth image”. In step S32, the second processor 26 superimposes the selection point image 230 at the first position corresponding to a position indicated by the updated position information on the selection point among positions (coordinates) on the corrected input image 210A based on the updated position information on the selection point.

The second processor 26 generates the second superimposed image 250 as described above, and then causes the projection device 22 to project the second superimposed image 250 (step S33). Specifically, in step S33, the second processor 26 controls the projection device 22 to project the image light L representing the second superimposed image 250 based on image data indicating the second superimposed image 250. After causing the projection device 22 to project the second superimposed image 250, the second processor 26 ends the fourth process. The second processor 26 executes the fourth process described above each time the updated position information on the selection point is received from the first display device 10.

In the following description, in order to distinguish the second superimposed image 250 visually recognized as a display image by the user from the second superimposed image 250 generated by the second processor 26, the second superimposed image 250 visually recognized as the display image by the user may be referred to as a “second superimposed display image 250A”. The second processor 26 executes the fourth process each time the updated position information on the selection point is received from the first display device 10, so that the user can visually recognize a state in which the selection point image 230 in the second superimposed display image 250A displayed on the projection surface 100 moves following the moving operation of the user and a shape of the corrected input image 210A in the second superimposed display image 250A changes along with the movement of the selection point.

The first processor 15 of the first display device 10 executes the third process according to the software of the image adjustment application, the second processor 26 of the second display device 20 executes the fourth process according to the image shape correction program, and thus the display method further including the following two processes is implemented. That is, the display method according to the embodiment further includes: receiving, by the first display device 10, the moving operation of changing the position of the selection point; and projecting, by the second display device 20, the second superimposed image 250 including the input image 210 whose shape is corrected based on the position of the selection point.

FIG. 11 shows an example of the second superimposed image 250 in which the selection point image 230 is superimposed on the corrected input image 210A. In FIG. 11, the corrected input image 210A is an image in which trapezoidal distortion in an opposite direction is applied to the input image 210 by the moving operation of the selection point. As shown in FIG. 11, the second superimposed image 250 includes the selection point image 230 corresponding to the selection point. The position of the selection point image 230 in the second superimposed image 250 is the first position corresponding to the position indicated by the updated position information on the selection point among positions on the corrected input image 210A.

Although FIG. 11 shows an example in which the second superimposed image 250 includes one selection point image 230, in practice, a selection operation of selecting a plurality of control points P and a moving operation of changing positions of the plurality of selection points are performed in order to apply the trapezoidal distortion in the opposite direction to the input image 210, and thus the actual second superimposed image 250 is an image including a plurality of selection point images 230.

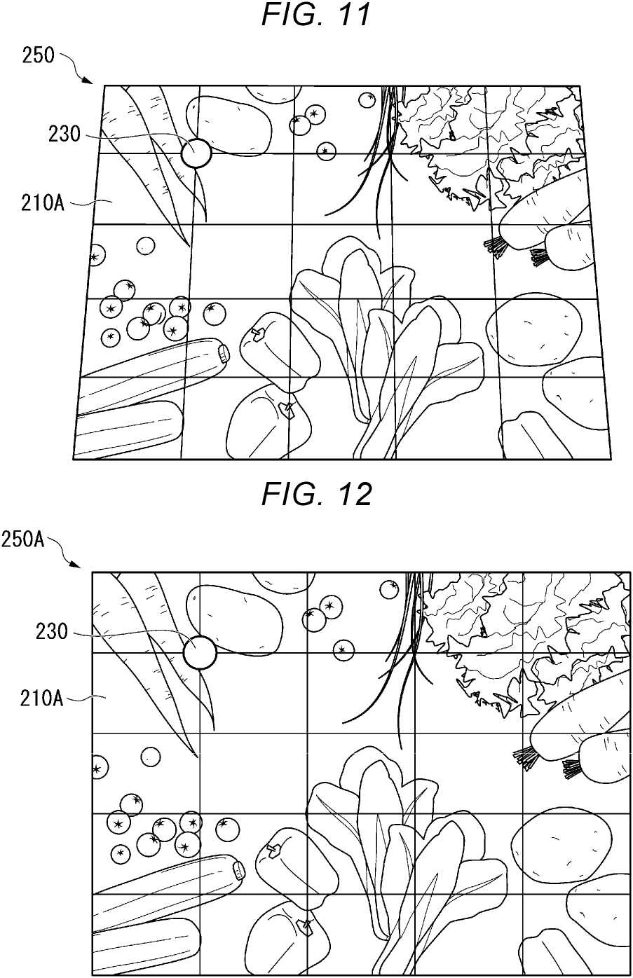

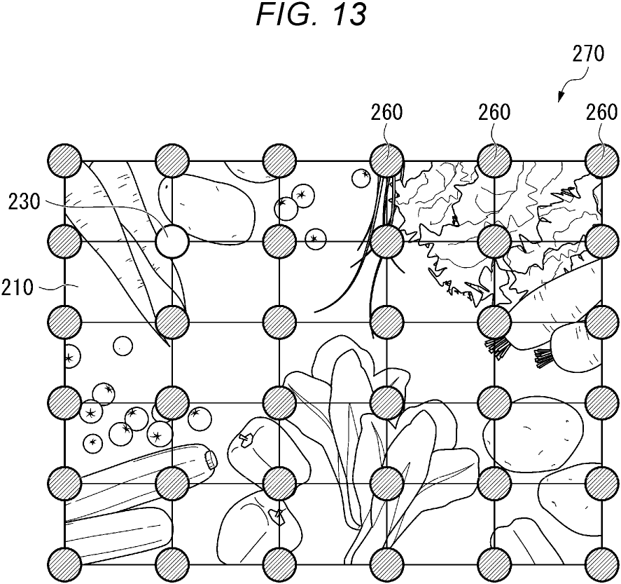

FIG. 12 shows the second superimposed display image 250A that is visually recognized as a display image by the user when the second superimposed image 250 shown in FIG. 11 is projected onto the projection surface 100. As shown in FIG. 12, the second superimposed image 250 projected onto the projection surface 100 is visually recognized by the user as a rectangular second superimposed display image 250A without trapezoidal distortion. In this way, the user can correct the image projected on the projection surface 100 to an image without distortion by performing the moving operation of changing the position of the selection point in the grid pattern image 220 displayed as the GUI on the display device 12 while viewing the image projected on the projection surface 100.

### Effects of Embodiment

As described above, the display method according to the embodiment includes: displaying, by the first display device 10, the grid pattern image 220 including the plurality of control points P; receiving, by the first display device 10, the selection operation of selecting the selection point that is at least one control point P among the plurality of control points P; and projecting, by the second display device 20 different from the first display device 10, the first superimposed image 240 including the selection point image 230 corresponding to the selection point at the first position corresponding to the position of the selection point in the grid pattern image 220.

According to the display method according to the embodiment, the user can easily determine to which position on the first superimposed image 240 projected by the second display device 20 the position of the selection point selected from the plurality of control points P in the grid pattern image 220 displayed on the first display device 10 corresponds. Therefore, according to the display method according to the embodiment, it is possible to improve convenience when the user operates the selection point.

In the display method according to the present embodiment, the first superimposed image 240 is an image in which the selection point image 230 is superimposed on the input image 210, and the selection point image 230 has the first color based on the color indicated by at least one pixel in the predetermined range from the first position in the input image 210 among the pixels in the input image 210.

According to the display method according to the embodiment, since the selection point image 230 has the first color based on the color indicated by at least one pixel in the predetermined range from the first position, the user can more easily determine to which position on the first superimposed image 240 the position of the selection point selected from the plurality of control points P in the grid pattern image 220 corresponds.

In the display method according to the embodiment, the first color is the complementary color of the second color determined based on the color indicated by the at least one pixel in the predetermined range from the first position among the pixels in the input image 210.

According to the display method according to the embodiment, since the first color in the selection point image 230 is the complementary color of the second color, the user can more easily determine to which position on the first superimposed image 240 the position of the selection point selected from the plurality of control points P in the grid pattern image 220 corresponds.

The display method according to the embodiment further includes: receiving, by the first display device 10, the moving operation of changing the position of the selection point; and projecting, by the second display device 20, the second superimposed image 250 including the input image 210 whose shape is corrected based on the position of the selection point.

According to the display method according to the embodiment, the user can correct the image displayed on the projection surface 100 to any desired shape by performing the moving operation of changing the position of the selection point in the grid pattern image 220 displayed as the GUI on the display device 12 while viewing the image displayed on the projection surface 100.

The display system 1 according to the embodiment includes: the first display device 10 including the first processor 15 configured to display the grid pattern image 220 including the plurality of control points P on the display device 12 and to receive the selection operation of selecting the selection point that is at least one control point P among the plurality of control points P; and the second display device 20 different from the first display device 10, the second display device 20 including the second processor 26 configured to cause the projection device 22 to project the first superimposed image 240 including the selection point image 230 corresponding to the selection point at the first position corresponding to the position of the selection point in the grid pattern image 220.

According to the display system 1 according to the embodiment, the user can easily determine to which position on the first superimposed image 240 projected by the second display device 20 the position of the selection point selected from the plurality of control points P in the grid pattern image 220 displayed on the first display device 10 corresponds. Therefore, it is possible to improve convenience when the user operates the selection point.

Although the embodiment of the present disclosure is described above, the technical scope of the present disclosure is not limited to the above embodiment, and various modifications can be made without departing from the gist of the present disclosure. Hereinafter, modifications of the present disclosure will be described.

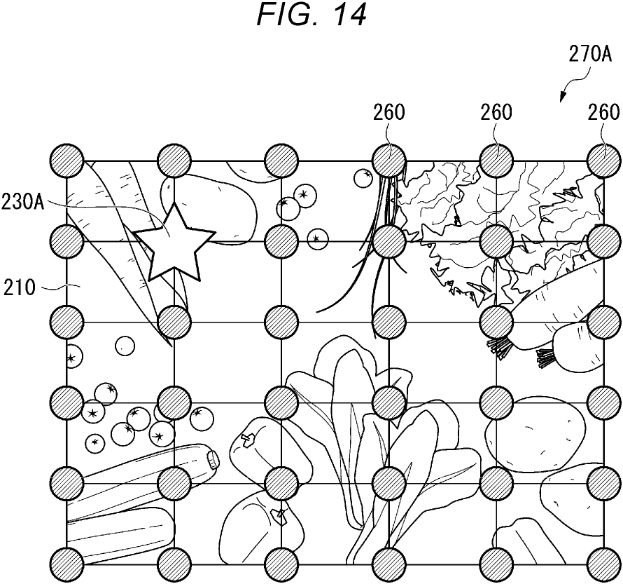

(1) In the above embodiment, the case where the first superimposed image 240 corresponding to the third image includes the selection point image 230 corresponding to the second image is exemplified, but the present disclosure is not limited thereto. FIG. 13 shows a first superimposed image 270 that is a modification of the third image. As shown in FIG. 13, the first superimposed image 270 corresponding to the third image may include, in addition to the selection point image 230, a non-selection point image 260 corresponding to a non-selection point that is a control point P other than the selection point among the plurality of control points P in the grid pattern image 220. The non-selection point image 260 corresponds to a “fifth image”.

A position of the non-selection point image 260 in the first superimposed image 270 is a second position corresponding to a position of the non-selection point in the grid pattern image 220. The first superimposed image 270 is an image in which the selection point image 230 is superimposed at the first position on the input image 210 and the non-selection point image 260 is superimposed at the second position on the input image 210. For example, when the control point P8 is selected as the selection point among the control points P1 to P36 in the grid pattern image 220, as shown in FIG. 13, the non-selection point image 260 is superimposed at the second position corresponding to a position of a control point P other than the control point P8 in the grid pattern image 220 among the positions on the input image 210.

In the first superimposed image 270, the selection point image 230 is in a first display manner, and the non-selection point image 260 is in a second display manner different from the first display manner. Similarly to the first superimposed image 240 shown in FIG. 6, the selection point image 230 in the first superimposed image 270 also has a circular shape and the first color that is the complementary color of the second color. However, the shape and the color of the selection point image 230 are not limited thereto.

As an example, the non-selection point image 260 in the first superimposed image 270 has a circular shape and has a color different from that of the selection point image 230. The shape of the non-selection point image 260 is not limited to the circular shape, and may be a shape different from that of the selection point image 230. In addition, a size of the non-selection point image 260 may be different from a size of the selection point image 230.

(2) For example, in the modification according to (1), when the second display device 20 operates in a first display mode, the second image may be in the first display manner, and when the second display device 20 operates in a second display mode, the second image may be in a third display manner different from the first display manner and the second display manner. For example, the first display mode is a mode that is set when an operator performs an adjustment operation of the second display device 20 in a period of time in which there is no spectator who views an image projected from the second display device 20. The second display mode is a mode that is set when the adjustment operation of the second display device 20 is performed in such a manner that no spectator is aware of the adjustment operation in a period of time in which the spectator is present.

When the second display device 20 operates in the first display mode as described above, the display manner of the second image is preferably set to the first display manner in which the second image is more conspicuous. FIG. 14 shows a first superimposed image 270A that is a modification of the third image. As shown in FIG. 14, when the second display device 20 operates in the first display mode, the first superimposed image 270A may include a selection point image 230A (second image) having a star shape and the non-selection point image 260 having a circular shape. Accordingly, since the first superimposed image 270A including the more conspicuous selection point image 230A is projected on the projection surface 100, convenience when the operator performs the adjustment operation is further improved. As described above, when the second display device 20 operates in the first display mode, the shape of the second image is not limited to the star shape, a size of the second image may be increased, the first color of the second image may be the complementary color of the second color, or the second image may be an animated image (moving image).

In addition, when the second display device 20 operates in the second display mode as described above, the display manner of the second image is preferably set to the third display manner in which the second image is less conspicuous. For example, when the second display device 20 operates in the second display mode, the shape of the second image may be maintained in the circular shape, the size of the second image may be decreased, the first color of the second image may be a color similar to that of the input image 210, transparency processing may be performed inside the second image, or the second image may be a still image.

(3) For example, in the modification according to (1) or (2), when the second display device 20 operates in the first display mode, the third image may include both the second image and the fifth image, and when the second display device 20 operates in the second display mode, the third image may include the second image among the second image and the fifth image. For example, when the second display device 20 operates in the first display mode, the third image is the first superimposed image 270 shown in FIG. 13 or the first superimposed image 270A shown in FIG. 14. In addition, for example, when the second display device 20 operates in the second display mode, the third image is the first superimposed image 240 shown in FIG. 6.

(4) In the above embodiment, the second display device 20 generates the first superimposed image 240 that is the third image and the second superimposed image 250 that is the sixth image based on the position information and the updated position information on the selection point received from the first display device 10. The present disclosure is not limited thereto, and the first display device 10 may generate the first superimposed image 240 and the second superimposed image 250 based on the position information and the updated position information on the selection point. In this case, the first display device 10 transmits image data indicating the first superimposed image 240 and image data indicating the second superimposed image 250 to the second display device 20. The second display device 20 projects the first superimposed image 240 and the second superimposed image 250 onto the projection surface 100 based on the two pieces of image data received from the first display device 10.

A display method according to an aspect of the present disclosure may have the following configuration.

The display method according to the aspect of the present disclosure includes: displaying, by a first display device, a first image including a plurality of control points; receiving, by the first display device, a first operation of selecting a selection point that is at least one control point among the plurality of control points; and projecting, by a second display device different from the first display device, a third image including a second image corresponding to the selection point, wherein a position of the second image in the third image is a first position corresponding to a position of the selection point in the first image.

In the display method according to the aspect of the present disclosure, the third image may be an image in which the second image is superimposed on a fourth image, and the second image may have a first color based on a color indicated by at least one pixel, among pixels in the fourth image, in a predetermined range from the first position in the fourth image.

In the display method according to the aspect of the present disclosure, the first color may be a complementary color of a second color determined based on the at least one pixel in the predetermined range from the first position among the pixels in the fourth image.

In the display method according to the aspect of the present disclosure, the third image may include a fifth image corresponding to a non-selection point that is a control point other than the selection point among the plurality of control points, a position of the fifth image in the third image may be a second position corresponding to a position of the non-selection point in the first image, the second image may be in a first display manner, and the fifth image may be in a second display manner different from the first display manner.

In the display method according to the aspect of the present disclosure, when the second display device operates in a first display mode, the second image may be in the first display manner, and when the second display device operates in a second display mode, the second image may be in a third display manner different from the first display manner and the second display manner.

In the display method according to the aspect of the present disclosure, when the second display device operates in a first display mode, the third image may include both the second image and the fifth image, and when the second display device operates in the second display mode, the third image may include the second image among the second image and the fifth image.

The display method according to the aspect of the present disclosure may further include: receiving, by the first display device, a second operation of changing a position of the selection point; and projecting, by the second display device, a sixth image including the fourth image whose shape is corrected based on the position of the selection point.

A display system according to an aspect of the present disclosure may have the following configuration.

The display system according to the aspect of the present disclosure includes: a first display device including a first processor configured to display a first image including a plurality of control points on a display device and to receive a first operation of selecting a selection point that is at least one control point among the plurality of control points; and a second display device different from the first display device, the second display device including a second processor configured to control a projection device to project a third image including a second image corresponding to the selection point, wherein a position of the second image in the third image is a first position corresponding to a position of the selection point in the first image.

What is claimed is:

1. A display method comprising:
displaying, by a first display device, a first image including a plurality of control points;
receiving, by the first display device, a first operation of selecting a selection point that is at least one control point among the plurality of control points; and
projecting, by a second display device different from the first display device, a third image including a second image corresponding to the selection point, wherein
a position of the second image in the third image is a first position corresponding to a position of the selection point in the first image.

2. The display method according to claim 1, wherein
the third image is an image in which the second image is superimposed on a fourth image, and
the second image has a first color based on a color indicated by at least one pixel, among pixels in the fourth image, in a predetermined range from the first position in the fourth image.

3. The display method according to claim 2, wherein
the first color is a complementary color of a second color determined based on the color indicated by the at least one pixel.

4. The display method according to claim 1, wherein
the third image includes a fifth image corresponding to a non-selection point that is a control point other than the selection point among the plurality of control points,
a position of the fifth image in the third image is a second position corresponding to a position of the non-selection point in the first image,
the second image is in a first display manner, and
the fifth image is in a second display manner different from the first display manner.

5. The display method according to claim 4, wherein
when the second display device operates in a first display mode,
the second image is in the first display manner, and
when the second display device operates in a second display mode,
the second image is in a third display manner different from the first display manner and the second display manner.

6. The display method according to claim 4, wherein
when the second display device operates in a first display mode,
the third image includes both the second image and the fifth image, and
when the second display device operates in a second display mode,
the third image includes the second image among the second image and the fifth image.

7. The display method according to claim 2, further comprising:
receiving, by the first display device, a second operation of changing a position of the selection point; and
projecting, by the second display device, a sixth image including the fourth image whose shape is corrected based on the position of the selection point.

8. A display system comprising:
a first display device including a first processor configured to display a first image including a plurality of control points on a display device and to receive a first operation of selecting a selection point that is at least one control point among the plurality of control points; and
a second display device different from the first display device, the second display device including a second processor configured to control a projection device to project a third
image including a second image corresponding to the selection point, wherein
a position of the second image in the third image is a first position corresponding to a position of the selection point in the first image.
